(19) United States
(12) Patent Application Publication
(10) Pub. No.: US 2024/0354585 A1
(43) Pub. Date: Oct. 24, 2024

(54) OPTIMIZING DEEP LEARNING RECOMMENDER MODEL DATA PIPELINES WITH REINFORCEMENT LEARNING

(71) Applicant: Netflix, Los Gatos, CA (US)

(72) Inventors: Kabir Nagrecha, San Diego, CA (US); Lingyi Liu, Pleasanton, CA (US); Pablo A. Delgado Aqueveque, San Jose, CA (US); Prasanna Padmanabhan, San Jose, CA (US)

(21) Appl. No.: 18/630,074

(22) Filed: Apr. 9, 2024

Related U.S. Application Data
(60) Provisional application No. 63/497,195, filed on Apr. 19, 2023.

(51) Int. Cl. G06N 3/092

(52) U.S. Cl. CPC G06N 3/092

(57) ABSTRACT

A computer-implemented method for leveraging reinforcement learning to optimize data ingestion in a deep learning recommender model training pipeline. For example, the discussed methods and systems introduce a reinforcement learning agent into a deep learning recommender model data ingestion pipeline to avoid many symptoms of an un-optimized data ingestion pipeline including, but not limited to, out-of-memory errors, un-optimized user-defined-functions in the data ingestion pipeline, and poor responses to machine re-sizing. The discussed methods and systems teach the reinforcement learning agent to make resource allocation choices within the data ingestion pipeline that are motivated by outcomes that reduce pipeline latency and memory usage. Various other methods, systems, and computer-readable media are also disclosed.

### CROSS REFERENCE

This application claims the benefit of U.S. Provisional Application No. 63/497,195, filed on Apr. 19, 2023, the entire content of which is incorporated herein by reference.

### BACKGROUND

Deep learning recommender (DL-Rec) models are often implemented in modern product recommendation infrastructures. For example, recommendation systems commonly underpin many online services such as search, e-commerce, and entertainment. As companies invest more into developing high-cost clusters for DL-Rec model compute, it is increasingly important to improve the efficiency of DL-Rec model training pipelines. Unfortunately, the standard lessons and techniques for general deep learning model training optimization are often inapplicable to DL-Rec model training due to the unique needs of recommendation applications. In particular, DL-Rec model training is often dominated by online data processing rather than model execution. Specifically, the unique design of DL-Rec model architectures have left training pipelines susceptible to inefficiencies in data ingestion.

In more detail, most deep learning (DL) architectures are dominated by high-intensity matrix operators, and standard tooling for DL training optimization has evolved to address this challenge. In such cases, model execution dominates training time to such a degree that data ingestion procedures (e.g., disk loading, shuffling, etc.) can be hidden underneath the matrix operation times. DL-Rec models, however, do not fit this pattern.

To illustrate, background FIG. 1 shows a typical DL-Rec architecture 100. Recommender datasets, such as the data sample 102, are typically composed of both sparse features (e.g., the categorical features 104) and dense features (e.g., the continuous features 106). As such, the typical DL-rec architecture 100 often includes ways to transform these two modalities into a common format. For example, as shown in FIG. 1, the DL-Rec architecture 100 employs one or more embedding tables 108 to transform the categorical features 104 into dense embedding vectors through a hash-table lookup. The resulting continuous vectors 110 can then be combined with the dense vectors and fed through some secondary DL model (e.g., such as feature interaction combination 112 and a multi-layer perceptron 114) to produce user-item probability ratings 116.

The embedding tables (e.g., such as the one or more embedding tables 108), which are often the single largest component of the DL-Rec architecture, do not require dense matrix multiplication. As such, DL-Rec models are often less compute-intensive than other architectures of a comparable size. This low computational intensity generally translates to low model latencies, which—in turn-fail to mask the cost of data loading and transformation. Improved GPU hardware and new model acceleration techniques only exacerbate this issue by reducing model runtimes and increasing the requisite data-loading throughput.

This is further complicated by the specific needs of recommender data pre-processing. In other domains (e.g., language modeling, computer vision) it may be practical to push data transformation to an offline pre-compute phase. In contrast, recommendation datasets are uniquely reliant on online processing-done just-in-time before the data is fed to the model. This is generally attributable to the scale, reusability, and volatility of recommendation data.

For example, with regard to scale, a recommender dataset for a popular application might span billions of interactions and require terabytes (or even petabytes) of disk space. Offline data transformation can bloat these already high storage costs further still. A common data processing operation is augmentation, which randomly modifies various aspects of a data sample to produce a completely new sample. Applying this operation offline might double or triple the size of an already massive dataset; the only practical way to run such transformations is to do them online.

Moreover, with regard to reusability, a single core dataset might be reused across multiple recommendation architectures. To illustrate, in a typical movie recommendation system, one model might rank rows of recommendations, while another might rank search results, and another might rank genres of recommendations. Each model would then require a different transformation procedure. In order to push data transformation to the offline phase, this singular dataset might have to be replicated dozens of times with minor variations. This is particularly problematic in light of the previously discussed scale challenge.

Additionally, with regard to volatility, recommendation datasets are updated frequently as new interactions are recorded. Any offline transformations would have to be re-run frequently as the dataset evolves. Incremental transformation is not always practical; some operations such as shuffling require the whole dataset be present. Repeatedly re-running offline transformation is generally an unattractive alternative to relying on online pre-processing.

As such, typical DL-model data processing ingestion techniques fail to meet the unique challenges present in DL-Rec models. Current DL-Rec model clusters often rely on horizontal scaling by replicating data pipelines across multiple machines. This significantly increases hardware demands and requires large-scale cluster redesigns. Thus, a data ingestion pipeline optimization solution is needed to improve DL-Rec model data-loading throughput in a general, scalable manner-without requiring the introduction of new resources.

### SUMMARY

As will be described in greater detail below, the present disclosure describes implementations that leverage reinforcement learning to optimize a DL-Rec model data ingestion pipeline thereby increasing training data throughput to a DL-Rec model. For example, implementations include configuring a reinforcement learning system in connection with a deep learning recommender (DL-Rec) model data ingestion pipeline of a DL-Rec model training cluster, the reinforcement learning system including an environment associated with the DL-Rec model training cluster, a reinforcement learning (RL) agent, and an action space of possible actions for the RL agent to take relative to the DL-Rec model data ingestion pipeline, and during data ingestion into the DL-Rec model data ingestion pipeline and execution of a corresponding DL-Rec model, providing live feedback detailing performance of the DL-Rec model data ingestion pipeline to the RL agent, wherein providing the live feedback to the RL agent further causes the RL agent to: reevaluate the environment associated with the DL-Rec model training cluster, select one or more actions of the possible actions within the action space that improve performance of the DL-Rec model data ingestion pipeline within the reevaluated environment, and reallocate computational resources of the environment associated with the DL-Rec model training cluster according to the selected one or more actions.

In one or more examples, the environment associated with the DL-Rec model training cluster includes static computational resources, variable RL agent-uncorrelated computational resources, and RL agent-modified computational resources. Additionally, in at least one example, static computational resources includes DRAM-CPU bandwidth and CPU processing speed, variable RL agent-uncorrelated computational resources include DL-Rec model latency, and RL agent-modified computational resources include current latency of the DL-Rec model data ingestion pipeline, a number of available CPUs, and an amount of free memory space.

In one or more examples, reevaluating the environment associated with the DL-Rec model training cluster includes determining that a change has occurred relative to one or more of the static computational resources or the RL agent-modified computational resources. Additionally, in some examples, reallocating computational resources of the environment associated with the DL-Rec model training cluster according to the selected one or more actions includes reallocating one or more RL agent-modified computational resources. In at least one example, the RL agent includes a machine learning model with a three-layer multi-layer perceptron architecture using a ReLU activation function.

In one or more examples, the action space of possible actions for the RL agent to take relative to the DL-Rec model data ingestion pipeline includes an incremental action space that allows the RL agent to choose to “raise-by-one,” “maintain,” “lower-by-one,” “raise-by-five,” or “lower-by-five” at every step. In at least one example, the DL-Rec model data ingestion pipeline includes a sequence of data processing tasks that transforms a recommender dataset for training the DL-Rec model. In one or more examples, the sequence of data processing tasks includes loading samples from a base dataset in a disk read operation, using the samples to fill a batch for DL-Rec model training, shuffling the samples within the batch, optimizing one or more user-defined-functions, and prefetching multiple batches of samples into a GPU memory. Moreover, in at least one example, selecting one or more actions of the possible actions within the action space that improve performance of the DL-Rec model data ingestion pipeline within the reevaluated environment includes selecting one or more actions according to a reward function that approaches zero as memory consumption nears 100%.

Some examples described herein include a system with at least one physical processor and physical memory including computer-executable instructions that, when executed by the at least one physical processor, cause the at least one physical processor to perform various acts. In at least one example, the computer-executable instructions, when executed by the at least one physical processor, cause the at least one physical processor to perform acts including configuring a reinforcement learning system in connection with a DL-Rec model data ingestion pipeline of a DL-Rec model training cluster, the reinforcement learning system including an environment associated with the DL-Rec model training cluster, an RL agent, and an action space of possible actions for the RL agent to take relative to the DL-Rec model data ingestion pipeline, and during data ingestion into the DL-Rec model data ingestion pipeline and execution of a corresponding DL-Rec model, providing live feedback detailing performance of the DL-Rec model data ingestion pipeline to the RL agent, wherein providing the live feedback to the RL agent further causes the RL agent to: reevaluate the environment associated with the DL-Rec model training cluster, select one or more actions of the possible actions within the action space that improve performance of the DL-Rec model data ingestion pipeline within the reevaluated environment, and reallocate computational resources of the environment associated with the DL-Rec model training cluster according to the selected one or more actions.

In some examples, the above-described method is encoded as computer-readable instructions on a computer-readable medium. In one example, the computer-readable instructions, when executed by at least one processor of a computing device, cause the computing device to configure a reinforcement learning system in connection with a DL-Rec model data ingestion pipeline of a DL-Rec model training cluster, the reinforcement learning system including an environment associated with the DL-Rec model training cluster, an RL agent, and an action space of possible actions for the RL agent to take relative to the DL-Rec model data ingestion pipeline, and during data ingestion into the DL-Rec model data ingestion pipeline and execution of a corresponding DL-Rec model, provide live feedback detailing performance of the DL-Rec model data ingestion pipeline to the RL agent, wherein providing the live feedback to the RL agent further causes the RL agent to: reevaluate the environment associated with the DL-Rec model training cluster, select one or more actions of the possible actions within the action space that improve performance of the DL-Rec model data ingestion pipeline within the reevaluated environment, and reallocate computational resources of the environment associated with the DL-Rec model training cluster according to the selected one or more actions.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a background figure that illustrates a typical deep learning recommender architecture in accordance with one or more implementations.

FIG. 2 illustrates an exemplary training cluster networking environment in accordance with one or more implementations.

FIG. 3 illustrates a data ingestion pipeline in accordance with one or more implementations.

FIG. 4 illustrates an overview of a reinforcement learning system configured by a deep learning recommender system and run in parallel with a deep learning recommender model in accordance with one or more implementations.

FIG. 5 illustrates a block diagram of an exemplary content distribution ecosystem.

FIG. 6 illustrates a block diagram of an exemplary distribution infrastructure within the content distribution ecosystem shown in FIG. 5.

FIG. 7 illustrates a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As discussed above, current DL model training techniques fail to adequately address the unique needs of DL-Rec model systems. In particular, model execution during DL-Rec model training operates at much lower latency than the corresponding online data processing. As such, DL-Rec model training pipelines are bottlenecked by data ingestion. This is particularly undesirable when a main task of DL-Rec models is to provide personalized, just-in-time item recommendations.

To provide a general, scalable solution to the DL-Rec model training data ingestion problem, the present disclosure is generally directed to a system that leverages reinforcement learning to understand and optimize distribution of computational resources across a data ingestion pipeline. As will be discussed in greater detail below, by introducing a reinforcement learning (RL) agent into the DL-Rec model data ingestion pipeline, the described system avoids many symptoms of an un-optimized data ingestion pipeline including, but not limited to, out-of-memory errors, un-optimized user-defined-functions (UDFs) in the data ingestion pipeline, and poor responses to machine re-sizing. By optimizing these issues, the described system increases throughput efficiency of the entire data ingestion pipeline which—in turn-increases the efficiency of one or more corresponding DL-Rec models that rely on the training data from that pipeline.

Features from any of the implementations described herein may be used in combination with one another in accordance with the general principles described herein. These and other implementations, features, and advantages will be more fully understood upon reading the following detailed description in conjunction with the accompanying drawings and claims.

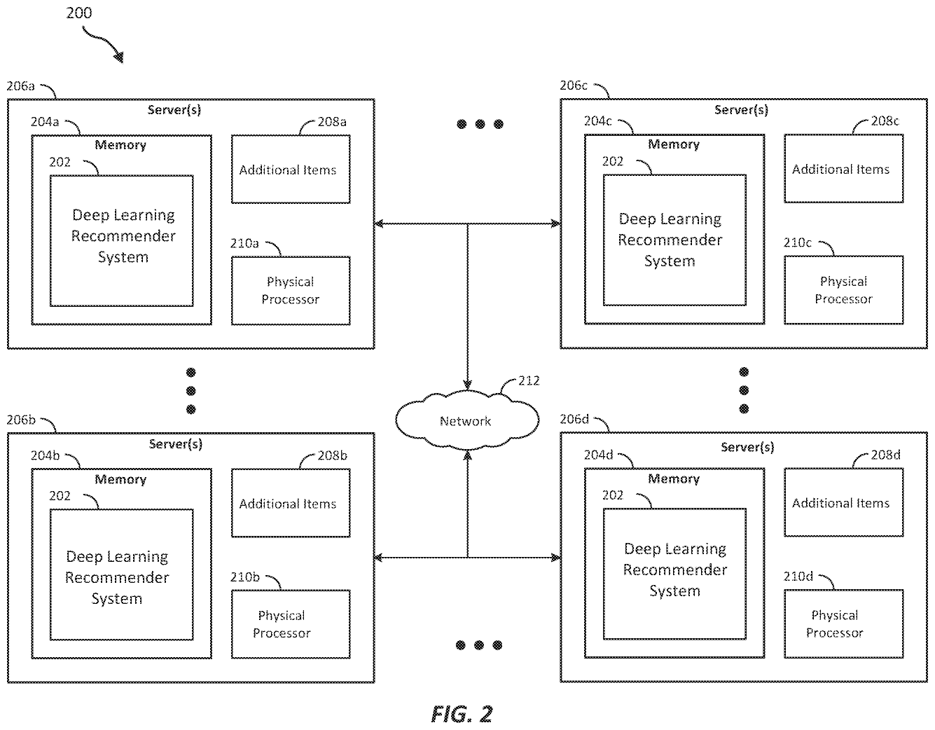

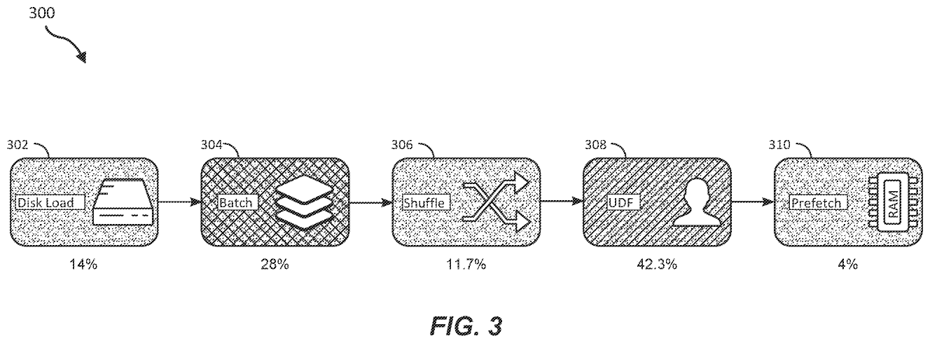

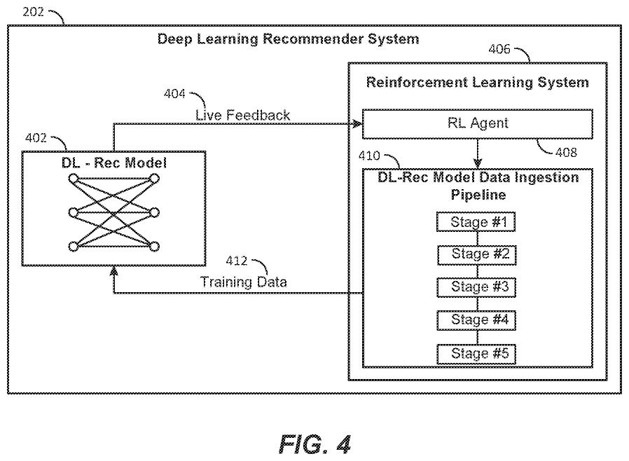

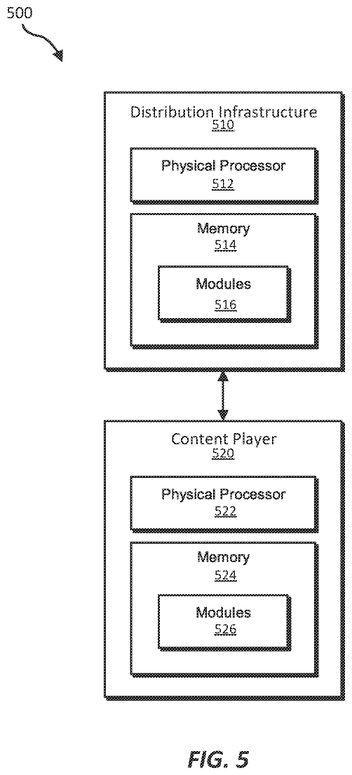

The following will provide, with reference to FIGS. 2-7, detailed descriptions of a deep learning recommender system that leverages reinforcement learning to optimize a DL-Rec model data ingestion pipeline. For example, an exemplary training cluster network environment is illustrated in FIG. 2 to show one or more servers operating within a training cluster to ingest (e.g., process, transform) DL-Rec model training data and apply DL-Rec models to that training data. FIG. 3 illustrates a typical data ingestion pipeline for a DL-Rec model during training. FIG. 4 illustrates an overview of a reinforcement learning system configured by the deep learning recommender system and run in parallel with a DL-Rec model during training. FIGS. 5, 6, and 7 provide additional detail with regard to an exemplary distribution infrastructure within an exemplary content distribution ecosystem and an exemplary content player that operates within the exemplary content distribution ecosystem

As just mentioned, FIG. 2 illustrates an exemplary training cluster networking environment 200 for optimizing data ingestion and DL-Rec model training. For example, the exemplary training cluster networking environment 200 includes server(s) 206a, 206b, 206c, and 206d and a network 212. As further shown, the server(s) 206a-206d include memories 204a, 204b, 204c, and 204d, additional items 208a, 208b, 208c, and 208d, as well as physical processors 210a, 210b, 210c, and 210d.

In one or more implementations, as shown in FIG. 2, the server(s) 206a-206d are computational devices used in training DL-Rec models. For example, the server(s) 206a-206d can function to ingest training data, process training data, tuning one or more DL-Rec models, and applying one or more DL-Rec models. In some implementations, any of the server(s) 206a-206d are any type of computational device such as standalone network servers, computer terminals, laptop computers, personal computing devices, and so forth.

As further shown in FIG. 2, a deep learning recommender system 202 is implemented as part of each of the memories 204a-204d on the server(s) 206a-206d, respectively. In one or more implementations, the deep learning recommender system 202 optimizes one or more data ingestion pipelines by introducing a reinforcement learning (RL) agent into the one or more data ingestion pipelines that is trained on historical job traces and tuned online to understand how to distribute computational resources across each data pipeline. In one or more implementations, the deep learning recommender system 202 also includes services that manage training and application of one or more DL-Rec models.

In one or more implementations, the memories 204a-204d generally represent any type or form of volatile or non-volatile storage device or medium capable of storing data and/or computer-readable instructions. In one example, the memories 204a-204d store, load, and/or maintain one or more of the components of the deep learning recommender system 202. Examples of the memories 204a-204d include, without limitation, Random Access Memory (RAM), Read Only Memory (ROM), flash memory, Hard-Disk Drives (HDDs), Solid-State Drives (SSDs), optical disk drives, caches, variations or combination of one or more of the same, and/or any other suitable storage memory.

In one or more implementations, the physical processors 210a-210d generally represent any type or form of hardware-implemented processing unit capable of interpreting and/or executing computer-readable instructions. In one implementation, the physical processors 210a-210d access and/or modify one or more of the components of the deep learning recommender system 202. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

In one or more implementations, the additional items 208a-208d include unprocessed DL-Rec model training data, processed DL-Rec model training data, DL-Rec models (e.g., trained or untrained), and any other type of data used by the deep learning recommender system 202.

As mentioned above, the server(s) 206a-206d are communicatively coupled through the network 212. In one or more implementations, the network 212 represents any type or form of communication network, such as the Internet, and includes one or more physical connections, such as a LAN, and/or wireless connections, such as a WAN. In at least one implementation, the network 212 represents combinations of networks.

Although FIG. 2 illustrates components of the exemplary training cluster networking environment 200 in one arrangement, other arrangements are possible. For example, in one implementation, the deep learning recommender system 202 operates on only one of the server(s) 206a-206d. In additional implementations, the exemplary training cluster networking environment 200 includes any number of server(s) across any number of hubs, regions, facilities, etc.

In order to help illustrate the shortcomings of existing DL-Rec model systems, additional detail is now provided with regard to common DL-Rec model systems and DL-Rec model data processing. In one or more examples, a typical DL model includes a chained sequence of matrix transformations, or layers, and non-linear activation functions. In at least one example, a DL-Rec model's matrix entries, or parameters, are tuned using a labeled dataset. In one or more implementations, this dataset consists of historical sample-label pairs, each of which serves as an example of some hidden relationship in the data that the model must approximate. Each sample typically includes multiple features, each feature reflecting a different aspect of the datapoint. For an e-commerce dataset, for example, a datapoint might be a user's purchase of an item. The features might include the item ID, the user ID, the item price, etc. The label might be a binary indicator reflecting whether or not the user purchased the item.

In one or more implementations, a DL-Rec model is tuned to fit a dataset in a training procedure known as stochastic gradient descent (SGD). In SGD, batches of samples are extracted from a dataset then fed into the model to produce some predictions. Next during SGD, the predictions are compared to known ground-truth labels to produce error values. The derivative chain rule is applied to minimize the error value with respect to the model parameters. Finally, a set of gradient updates are computed to update the DL-Rec model parameters.

As mentioned above, a key challenge in connection with DL-Rec model training lies in the structure of the training data. Recommendation training data is often categorical (e.g., a user ID, a product ID). Passing in such arbitrary identifiers directly to a series of matrix operations leads to nonsensical results. Instead, embedding tables are often employed to extract meaning from these categorical identities. In one or more implementations, an embedding table maps a categorical ID to a vector of continuous values. In some implementations, these continuous values are combined with any continuous sample features through an interaction procedure (e.g., concatenation). The resulting vector can then be fed through a standard training process such as SGD. During the SGD parameter updates, the embedding vectors will be updated as though they were matrix parameters. In some implementations, the embedding table can be seen as equivalent to transforming input IDs into one-hot vectors and feeding them into a standard DL model.

As such, the one or more embedding tables included in a typical DL-Rec model system is key to enabling personalized applications using deep learning. Despite this, the one or more embedding tables also introduce computational challenges. To illustrate, a company may have one billion users. If the company wants to use a DL-Rec model to recommend social media posts to the one billion users, the company must build an embedding table with one billion entries to accommodate all of the users. If the company uses a typical embedding vector depth (e.g., 128), with each vector entry being a 4-byte float, the resulting embedding table would require more than 512 gigabytes of memory. An embedding table this large would not fit into the memory of even the most state-of-the-art GPUs. While various techniques have been proposed to handle this issue, each technique introduces inaccuracies and/or requires powerful and expensive hardware upgrades.

As mentioned above, the embedding tables utilized by typical DL-Rec model systems introduce many computational challenges into the data ingestion pipeline for training DL-Rec models. FIG. 3 illustrates a typical data ingestion pipeline 300. Also shown is the percentage of pipeline latency attributable to each step to demonstrate the differing costs of data processing. In one or more implementations, a typical DL-Rec model training dataset is composed of historical user interactions with the target application (e.g., the system for which the recommendations are being made). A streaming service, for example, might record user interactions (i.e., plays, ratings) with movies and shows. Millions of such interactions could be recorded every day. In many implementations, recommender models must be retrained regularly to account for the dataset updates. Each recommender model in a group of such models might target a different aspect of the target application. For example, one recommender model might be used for ordering rows to present to users, while another might be used for column ordering. Individual recommender models have different features (i.e., columns) of the base dataset and might require a custom preprocessing pipeline. As such, it is generally impractical to push data preprocessing to the offline stage. Instead, per-model customization encourages online transformation of the same base dataset.

Thus, the data ingestion pipeline 300 includes data processing steps that can occur online in preparing data for training one or more DL-Rec models. For example, as shown in FIG. 3, at a step 302 samples are loaded from the base dataset in a disk read operation. In one or more implementations, each sample is represented as a dictionary of key-value pairs, mapping feature names to values. At a step 304, these samples are used to fill up a batch for SGD training. In at least one implementation, this is repeated until some significant number of batches are in memory. At a step 306, the samples are then shuffled to encourage some randomness in the SGD procedure to improve model robustness.

At a step 308, one or more user-defined functions are applied to the samples. For example, in one implementation, a custom dictionary lookup operation is used to extract relevant feature columns. To illustrate, product ID, user ID, user country, and total product watch time may be relevant columns. In some implementations, such user-defined functions may be fairly expensive on a feature-rich dataset. For instance, product ID, user ID, and user country may be categorical while total product watch time may be continuous. In some implementations random noise is applied to the continuous variable to augment the data and improve model robustness. At a step 310, to improve training times, several batches will be prefetched at once into GPU memory to overlap the next pipeline loading phase with model execution, trading memory for performance. At this point, the pipeline has finished producing a training batch for DL-Rec model consumption during a training cycle.

As mentioned above, the deep learning recommender system 202 optimizes a data ingestion pipeline (e.g., such as the typical data ingestion pipeline 300) by leveraging an adaptive and responsive reinforcement learning (RL) agent. In more detail, the general aim of reinforcement learning is to train an “agent,” or actor, using data collected from exploring an environment. The agent can choose from a set of actions in the environment based on the current state. The state is updated as a result of the action and a reward is computed to reflect the benefit produced as a result of the agent's action. The new state and reward are used to modify the agent in a way that encourages reward-positive actions and discourages reward-negative actions.

A variety of techniques can be used to construct this feedback loop. The Deep Q-Network (DQN) approach uses a deep learning model as its agent and SGD for the feedback loop. In the DON technique, the agent model is trained to approximate an unknown function Q, where Q(s, a) yields the reward for execution action a in the environment state(s). Then this agent model can compute an expected total reward for all possible a's at a given state s, then select the action that maximizes the expected reward. In one or more implementations, the action space is relatively small to make this search feasible, as excessively large action spaces are known to reduce model accuracy. In at least one implementation, manipulating the action space is known as action space shaping, and includes reducing and combining actions to simplify the space. In multi-discrete action spaces (e.g., a keyboard), wherein multiple simultaneous actions can be taken at once, the potential action space is exponential with a degree of the maximum number of simultaneous actions.

In one or more implementations, selecting an action from an action space requires understanding both the immediate and long-term rewards. In at least one implementation, to predict “overall” reward of an action, the Optimal Action Value Function is used to shape the agent's behaviors and teach the agent expected rewards over time. Thus, the agent learns a model of its environment and how its actions will change its state and impact its rewards. As such, the agent can actively make decisions in response to environmental changes.

In one or more examples, the deep learning recommender system 202 makes use of these reinforcement learning properties to overcome the complex and dynamic challenges surrounding data ingestion pipeline optimization. More specifically, the deep learning recommender system 202 implements a reinforcement learning system to address data ingestion issues that arise in connection with training DL-Rec models; these issues including, but not limited to: suboptimal performance on the DL-Rec model data ingestion pipeline, inability to scale as computational resource caps are changed, and a tendency to over allocate resources leading to out-of-memory errors. As such, the deep learning recommender system 202 implements a RL agent to actively evaluate its environment and collect feedback in real time. In one or more implementations, as discussed below, this RL agent is able to 1) fine-tune its understanding of user-defined function performance throughout training, 2) actively respond to changing computational resource caps, and 3) directly account for current memory usage in its decision-making.

In more detail, as shown in FIG. 4, the deep learning recommender system 202 configures a reinforcement learning system 406. In one or more implementations, the deep learning recommender system 202 configures the reinforcement learning system 406 including an environment, an RL agent 408, and an action space. Together, the environment, the RL agent 408, and the action space within the reinforcement learning system 406 operate in concert to optimize a DL-Rec model data ingestion pipeline 410 including any number of stages (e.g., such as the steps of the data ingestion pipeline 300 shown in FIG. 3). In one or more implementations, the RL agent 408 adapts and responds to live feedback 404 from a DL-Rec Model operating in parallel, while the DL-Rec model data ingestion pipeline 410 outputs training data 412 to the DL-Rec model 402.

In one or more implementations, the environment of the reinforcement learning system 406 reflects a state of the data ingestion pipeline and available computational hardware. Certain aspects of the environment are static (e.g., DRAM-CPU bandwidth), others are uncorrelated to the RL agent's actions (e.g., DL-Rec model latency), while others are directly impacted by the RL agent's actions (e.g., memory usage, CPU usage). In at least one implementation, the environment provides the RL agent with any and all information the RL agent needs to make an informed decision.

For example, in one or more implementations, the environment can include computational resources in any of various categories. In at least one implementation, the environment associated with a DL-Rec model training cluster (e.g., such as the exemplary training cluster networking environment 200 shown in FIG. 2) includes static computational resources, variable RL agent-uncorrelated computational resources, and RL agent-modified computational resources. In one or more examples, static computational resources include DRAM-CPU bandwidth (MB/s) and CPU processing speed (GHz). For example, the DRAM-CPU bandwidth can impact the value of prefetching and is found up front and is unchanged throughout training. The CPU processing speed can impact decision-making on resource allocation and is found up front and is unchanged throughout training.

In one or more examples, variable RL agent-uncorrelated computational resources include DL-Rec model latency. For example, model latency can include the actual model execution time and is updated regularly to improve estimation accuracy. In at least one example, model latency is unrelated to agent action.

In one or more examples, RL agent-modified computational resources include current latency of the DL-Rec model data ingestion pipeline, a number of available CPUs, and an amount of free memory space. For example, current pipeline latency allows the RL agent 408 to understand the performance of the current configuration. As such, the current pipeline latency may change based on actions taken by the RL agent 408. Additionally, the number of free CPUs allows the RL agent 408 to understand how many extra CPUs it has available to allocate. The number of free CPUs may change based on actions taken by the RL agent 408 or autoscaling. Furthermore, the amount of free memory space allows the RL agent 408 to understand how much memory it has free to increase prefetches/processing levels. The amount of free memory space may change based on actions taken by the RL agent 408.

In one or more implementations, these details are sufficient for the RL agent 408 to quickly grasp the problem setting associated with the DL-Rec model data ingestion pipeline. The static computational resources provide some immediate information while the other resources will help the RL agent 408 learn how its actions impact data pipeline performance. In at least one implementation, the RL agent reward is directly based on data pipeline latency and memory usage. In one example, the RL agent reward is models as:

$$R = latency \times ( 1 - \frac{{memory}_{used}}{{memory}_{total}} )$$

If prefetch is not used excessively, then the memory usage portion of this equation is largely irrelevant. According to the reward equation, the RL agent reward approaches zero as memory consumption nears 100%. This helps the deep learning recommender system 202 avoid out-of-memory outcomes.

As mentioned above, the deep learning recommender system 202 configures the reinforcement learning system 406 including the environment (just discussed), an RL agent 408, and an action space. In one or more implementations, the RL agent 408 includes a low-cost, lightweight architecture so as not to over-consume resources while a DL-Rec model 402 runs in parallel. In at least one implementation, the reinforcement learning system 406 is a three-layer multi-layer perceptron architecture using a ReLU activation function. In some examples, this architecture minimizes computational demand. Moreover, if the action space consists of less than 256 possible choices, this architecture only requires less than 200 FLOPs per iteration, which does not interfere excessively with training of the DL-Rec model 402.

In some implementations, the deep learning recommender system 202 trains the RL agent 408 in offline simulations to prepare the RL agent 408 for live deployment/tuning. For example, the deep learning recommender system 202 trains the RL agent 408 (or different versions of the RL agent 408) for a different common pipeline length (e.g., a 4-stage pipeline, a 5-stage pipeline such as shown in FIG. 3). During live data ingestion, the deep learning recommender system 202 fine-tunes the RL agent 408 using live feedback 404 from the DL-Rec model 402 to adapt the RL agent 408 for the current job.

Finally, as mentioned above, the deep learning recommender system 202 configures the reinforcement learning system 406 including an action space. In one or more implementations, the deep learning recommender system 202 reshapes the action space to improve accuracy. For example, if the RL agent 408 were allowed to directly select any distribution of resources, the size of the action space would be

$$( \frac{n + r - 1}{r - 1} )$$

where n is the number of CPUs and r is the number of pipeline stages (e.g., of the DL-Rec model data ingestion pipeline 410). On a typical setup with 128 CPUs over a 5-stage pipeline, this would yield 1.2e7 possible actions which would increase iteration compute costs to more than 6.1GFLOPS.

Instead, the deep learning recommender system 202 reshapes the action space incrementally. For example, at every step, the deep learning recommender system 202 allows the RL agent 408 to choose to “raise-by-one,” “maintain,” or “lower-by-one” the resource allocation of each stage. More specifically, the deep learning recommender system 202 allows the RL agent 408 to, for example, choose to “raise-by-one,” “maintain,” or “lower-by-one” memory-bound factors by megabyte units and/or processing-bound factors by CPU units. To improve search and convergence times, the deep learning recommender system 202 gives the RL agent 408 additional options of “raise-by-five” and “lower-by-five.” In total, this yields an incremental action space of 5ⁿ options. Because n is typically less than or equal to 5, the resulting incremental action space is more manageable.

Thus, as shown in FIG. 4, the deep learning recommender system 202 runs the reinforcement learning system 406 and the DL-Rec model 402 in parallel. In one or more implementations, the RL agent 408 responds to the live feedback 404 in real-time to make decisions within the action space as to how to allocate computational resources to the stages within the DL-Rec model data ingestion pipeline 410. It follows that the DL-Rec model data ingestion pipeline 410 generates training data 412 for the DL-Rec model 402. Thus, the deep learning recommender system 202 utilizes the reinforcement learning system 406 to optimize the DL-Rec model data ingestion pipeline 410 such that the DL-Rec model data ingestion pipeline 410 is generating DL-rec model training data at speeds that are comparable to the latency at which the DL-Rec model 402 runs-thereby eliminating the data ingestion bottlenecks that were common in previous DL-Rec systems.

In summary, previous DL-Rec systems were plagued by out-of-memory errors, unoptimized user-defined-functions, and poor responses to machine resizing-all within their data ingestion pipelines. Because the DL-Rec models themselves operated with low latency, entire systems were bottlenecked by issues that were common to these data ingestion pipelines. To solve these issues, the deep learning recommender system 202 configures the reinforcement learning system 406 to allow the RL agent 408 to learn about its environment (i.e., the available computational resources) and make decisions within an action space that are motivated by a reward that directly decreases data pipeline latency and memory usage. As such, the deep learning recommender system 202 teaches the RL agent 408 make accurate and efficient use of available computational resources while increasing the throughput of the DL-Rec model data ingestion pipeline 410. In doing so, the deep learning recommender system 202 provides a solution to existing problems DL-Rec modeling that prevented DL-Rec models from being used efficiently in connection with online, time-sensitive recommendation tasks such as those associated with e-commerce and digital entertainment.

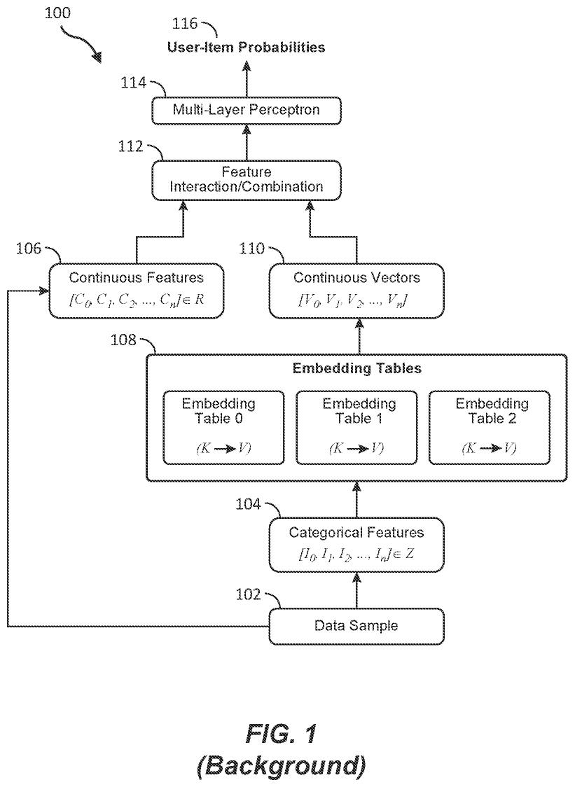

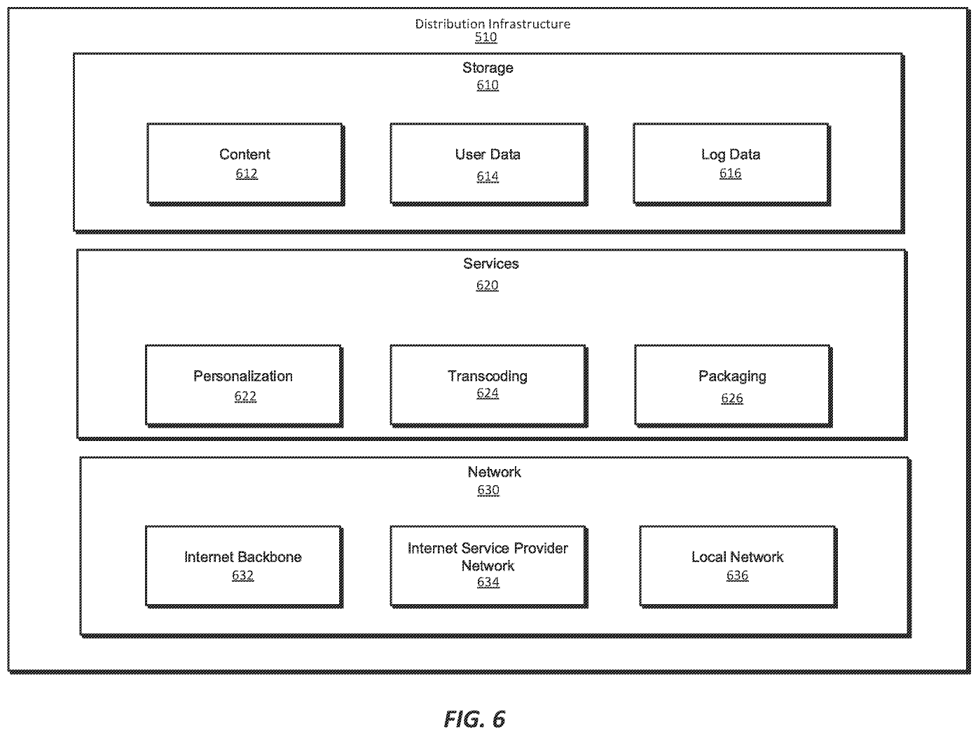

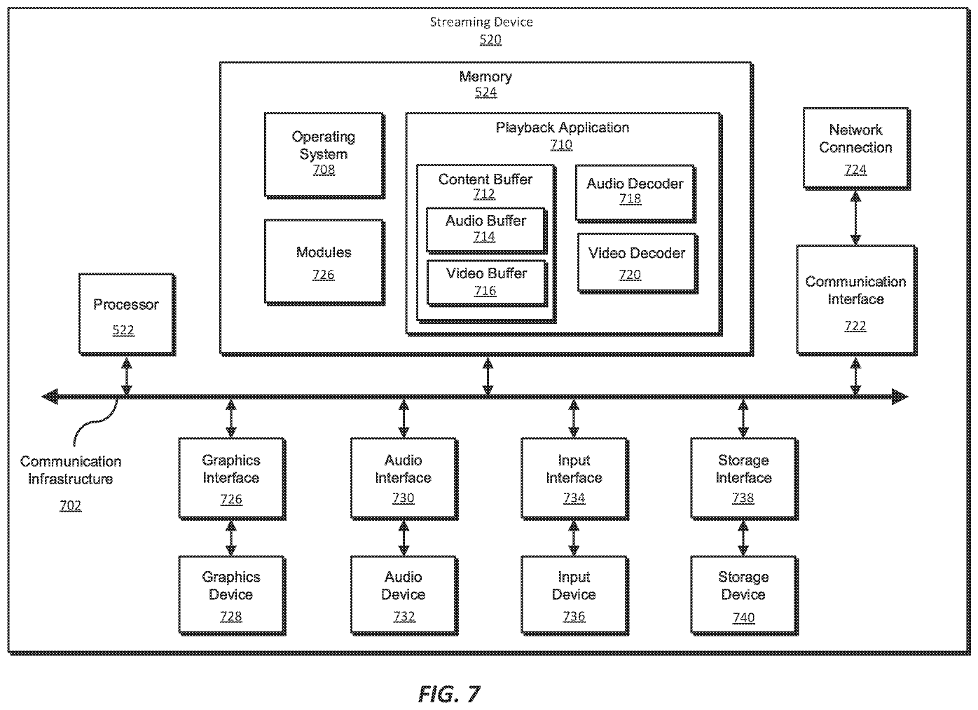

The following will provide, with reference to FIG. 5, detailed descriptions of exemplary ecosystems in which digital entertainment content is provisioned to end nodes and in which requests for content are steered to specific end nodes. The discussion corresponding to FIGS. 6 and 7 presents an overview of an exemplary distribution infrastructure and an exemplary content player used during digital entertainment playback sessions, respectively. These exemplary ecosystems and distribution infrastructures are implemented in any of the embodiments described above with reference to FIGS. 1-4.

FIG. 5 is a block diagram of a content distribution ecosystem 500 that includes a distribution infrastructure 510 in communication with a content player 520. In some embodiments, distribution infrastructure 510 is configured to encode data at a specific data rate and to transfer the encoded data to content player 520. Content player 520 is configured to receive the encoded data via distribution infrastructure 510 and to decode the data for playback to a user. The data provided by distribution infrastructure 510 includes, for example, audio, video, text, images, animations, interactive content, haptic data, virtual or augmented reality data, location data, gaming data, or any other type of data that is provided via streaming.

Distribution infrastructure 510 generally represents any services, hardware, software, or other infrastructure components configured to deliver content to end users. For example, distribution infrastructure 510 includes content aggregation systems, media transcoding and packaging services, network components, and/or a variety of other types of hardware and software. In some cases, distribution infrastructure 510 is implemented as a highly complex distribution system, a single media server or device, or anything in between. In some examples, regardless of size or complexity, distribution infrastructure 510 includes at least one physical processor 512 and memory 514. One or more modules 516 are stored or loaded into memory 514 to enable adaptive streaming, as discussed herein.

Content player 520 generally represents any type or form of device or system capable of playing audio and/or video content that has been provided over distribution infrastructure 510. Examples of content player 520 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 510, content player 520 includes a physical processor 522, memory 524, and one or more modules 526. Some or all of the adaptive streaming processes described herein is performed or enabled by modules 526, and in some examples, modules 516 of distribution infrastructure 510 coordinate with modules 526 of content player 520 to provide adaptive streaming of digital content.

In certain embodiments, one or more of modules 516 and/or 526 in FIG. 5 represent one or more software applications or programs that, when executed by a computing device, cause the computing device to perform one or more tasks. For example, and as will be described in greater detail below, one or more of modules 516 and 526 represent modules stored and configured to run on one or more general-purpose computing devices. One or more of modules 516 and 526 in FIG. 5 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 512 and 522 generally represent any type or form of hardware-implemented processing unit capable of interpreting and/or executing computer-readable instructions. In one example, physical processors 512 and 522 access and/or modify one or more of modules 516 and 526, respectively. Additionally or alternatively, physical processors 512 and 522 execute one or more of modules 516 and 526 to facilitate adaptive streaming of digital content. Examples of physical processors 512 and 522 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 514 and 524 generally represent any type or form of volatile or non-volatile storage device or medium capable of storing data and/or computer-readable instructions. In one example, memory 514 and/or 524 stores, loads, and/or maintains one or more of modules 516 and 526. Examples of memory 514 and/or 524 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 6 is a block diagram of exemplary components of distribution infrastructure 510 according to certain embodiments. Distribution infrastructure 510 includes storage 610, services 620, and a network 630. Storage 610 generally represents any device, set of devices, and/or systems capable of storing content for delivery to end users. Storage 610 includes a central repository with devices capable of storing terabytes or petabytes of data and/or includes distributed storage systems (e.g., appliances that mirror or cache content at Internet interconnect locations to provide faster access to the mirrored content within certain regions). Storage 610 is also configured in any other suitable manner.

As shown, storage 610 may store a variety of different items including content 612, user data 614, and/or log data 616. Content 612 includes television shows, movies, video games, user-generated content, and/or any other suitable type or form of content. User data 614 includes personally identifiable information (PII), payment information, preference settings, language and accessibility settings, and/or any other information associated with a particular user or content player. Log data 616 includes viewing history information, network throughput information, and/or any other metrics associated with a user's connection to or interactions with distribution infrastructure 510.

Services 620 includes personalization services 622, transcoding services 624, and/or packaging services 626. Personalization services 622 personalize recommendations, content streams, and/or other aspects of a user's experience with distribution infrastructure 510. Transcoding services 624 compress media at different bitrates which, as described in greater detail below, enable real-time switching between different encodings. Packaging services 626 package encoded video before deploying it to a delivery network, such as network 630, for streaming.

Network 630 generally represents any medium or architecture capable of facilitating communication or data transfer. Network 630 facilitates communication or data transfer using wireless and/or wired connections. Examples of network 630 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 6, network 630 includes an Internet backbone 632, an internet service provider network 634, and/or a local network 636. As discussed in greater detail below, bandwidth limitations and bottlenecks within one or more of these network segments triggers video and/or audio bit rate adjustments.

FIG. 7 is a block diagram of an exemplary implementation of content player 520 of FIG. 5. Content player 520 generally represents any type or form of computing device capable of reading computer-executable instructions. Content player 520 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 7, in addition to processor 522 and memory 524, content player 520 includes a communication infrastructure 702 and a communication interface 722 coupled to a network connection 724. Content player 520 also includes a graphics interface 726 coupled to a graphics device 728, an audio interface 730 coupled to an audio device 732, an input interface 734 coupled to an input device 736, and a storage interface 738 coupled to a storage device 740.

Communication infrastructure 702 generally represents any type or form of infrastructure capable of facilitating communication between one or more components of a computing device. Examples of communication infrastructure 702 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 524 generally represents any type or form of volatile or non-volatile storage device or medium capable of storing data and/or other computer-readable instructions. In some examples, memory 524 stores and/or loads an operating system 708 for execution by processor 522. In one example, operating system 708 includes and/or represents software that manages computer hardware and software resources and/or provides common services to computer programs and/or applications on content player 520.

Operating system 708 performs various system management functions, such as managing hardware components (e.g., graphics interface 726, audio interface 730, input interface 734, and/or storage interface 738). Operating system 708 also provides process and memory management models for playback application 710. The modules of playback application 710 includes, for example, a content buffer 712, an audio decoder 718, and a video decoder 720.

Playback application 710 is configured to retrieve digital content via communication interface 722 and play the digital content through graphics interface 726 and audio interface 730. Graphics interface 726 is configured to transmit a rendered video signal to graphics device 728. Audio interface 730 is configured to transmit a rendered audio signal to audio device 732. In normal operation, playback application 710 receives a request from a user to play a specific title or specific content. Playback application 710 then identifies one or more encoded video and audio streams associated with the requested title.

In one embodiment, playback application 710 begins downloading the content associated with the requested title by downloading sequence data encoded to the lowest audio and/or video playback bitrates to minimize startup time for playback. The requested digital content file is then downloaded into content buffer 712, which is configured to serve as a first-in, first-out queue. In one embodiment, each unit of downloaded data includes a unit of video data or a unit of audio data. As units of video data associated with the requested digital content file are downloaded to the content player 520, the units of video data are pushed into the content buffer 712. Similarly, as units of audio data associated with the requested digital content file are downloaded to the content player 520, the units of audio data are pushed into the content buffer 712. In one embodiment, the units of video data are stored in video buffer 716 within content buffer 712 and the units of audio data are stored in audio buffer 714 of content buffer 712.

A video decoder 720 reads units of video data from video buffer 716 and outputs the units of video data in a sequence of video frames corresponding in duration to the fixed span of playback time. Reading a unit of video data from video buffer 716 effectively de-queues the unit of video data from video buffer 716. The sequence of video frames is then rendered by graphics interface 726 and transmitted to graphics device 728 to be displayed to a user.

An audio decoder 718 reads units of audio data from audio buffer 714 and outputs the units of audio data as a sequence of audio samples, generally synchronized in time with a sequence of decoded video frames. In one embodiment, the sequence of audio samples is transmitted to audio interface 730, which converts the sequence of audio samples into an electrical audio signal. The electrical audio signal is then transmitted to a speaker of audio device 732, which, in response, generates an acoustic output.

In situations where the bandwidth of distribution infrastructure 510 is limited and/or variable, playback application 710 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 726 is configured to generate frames of video data and transmit the frames of video data to graphics device 728. In one embodiment, graphics interface 726 is included as part of an integrated circuit, along with processor 522. Alternatively, graphics interface 726 is configured as a hardware accelerator that is distinct from (i.e., is not integrated within) a chipset that includes processor 522.

Graphics interface 726 generally represents any type or form of device configured to forward images for display on graphics device 728. For example, graphics device 728 is fabricated using liquid crystal display (LCD) technology, cathode-ray technology, and light-emitting diode (LED) display technology (either organic or inorganic). In some embodiments, graphics device 728 also includes a virtual reality display and/or an augmented reality display. Graphics device 728 includes any technically feasible means for generating an image for display. In other words, graphics device 728 generally represents any type or form of device capable of visually displaying information forwarded by graphics interface 726.

As illustrated in FIG. 7, content player 520 also includes at least one input device 736 coupled to communication infrastructure 702 via input interface 734. Input device 736 generally represents any type or form of computing device capable of providing input, either computer or human generated, to content player 520. Examples of input device 736 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 520 also includes a storage device 740 coupled to communication infrastructure 702 via a storage interface 738. Storage device 740 generally represents any type or form of storage device or medium capable of storing data and/or other computer-readable instructions. For example, storage device 740 is a magnetic disk drive, a solid-state drive, an optical disk drive, a flash drive, or the like. Storage interface 738 generally represents any type or form of interface or device for transferring data between storage device 740 and other components of content player 520.

### EXAMPLE EMBODIMENTS

Example 1: A computer-implemented method for leveraging reinforcement learning to optimize a DL-Rec model data ingestion pipeline thereby increasing training data throughput to a DL-Rec model. For example, the method may include configuring a reinforcement learning system in connection with a deep learning recommender (DL-Rec) model data ingestion pipeline of a DL-Rec model training cluster, the reinforcement learning system including an environment associated with the DL-Rec model training cluster, a reinforcement learning (RL) agent, and an action space of possible actions for the RL agent to take relative to the DL-Rec model data ingestion pipeline, and during data ingestion into the DL-Rec model data ingestion pipeline and execution of a corresponding DL-Rec model, providing live feedback detailing performance of the DL-Rec model data ingestion pipeline to the RL agent, wherein providing the live feedback to the RL agent further causes the RL agent to: reevaluate the environment associated with the DL-Rec model training cluster, select one or more actions of the possible actions within the action space that improve performance of the DL-Rec model data ingestion pipeline within the reevaluated environment, and reallocate computational resources of the environment associated with the DL-Rec model training cluster according to the selected one or more actions.

Example 2: The computer-implemented method of Example 1, wherein the environment associated with the DL-Rec model training cluster includes static computational resources, variable RL agent-uncorrelated computational resources, and RL agent-modified computational resources.

Example 3: The computer-implemented method of any of Examples 1 and 2, wherein: static computational resources includes DRAM-CPU bandwidth and CPU processing speed, variable RL agent-uncorrelated computational resources include DL-Rec model latency, and RL agent-modified computational resources include current latency of the DL-Rec model data ingestion pipeline, a number of available CPUs, and an amount of free memory space.

Example 4: The computer-implemented method of any of Examples 1-3, wherein reevaluating the environment associated with the DL-Rec model training cluster includes determining that a change has occurred relative to one or more of the static computational resources or the RL agent-modified computational resources.

Example 5: The computer-implemented method of any of Examples 1-4, wherein reallocating computational resources of the environment associated with the DL-Rec model training cluster according to the selected one or more actions includes reallocating one or more RL agent-modified computational resources.

Example 6: The computer-implemented method of any of Examples 1-5, wherein the RL agent includes a machine learning model with a three-layer multi-layer perceptron architecture using a ReLU activation function.

Example 7: The computer-implemented method of any of Examples 1-6, wherein the action space of possible actions for the RL agent to take relative to the DL-Rec model data ingestion pipeline includes an incremental action space that allows the RL agent to choose to “raise-by-one,” “maintain,” “lower-by-one,” “raise-by-five,” or “lower-by-five” at every step.

Example 8: The computer-implemented method of any of Examples 1-7, wherein the DL-Rec model data ingestion pipeline includes a sequence of data processing tasks that transforms a recommender dataset for training the DL-Rec model.

Example 9: The computer-implemented method of any of Examples 1-8, wherein the sequence of data processing tasks includes loading samples from a base dataset in a disk read operation, using the samples to fill a batch for DL-Rec model training, shuffling the samples within the batch, optimizing one or more user-defined-functions, and prefetching multiple batches of samples into a GPU memory.

Example 10: The computer-implemented method of any of Examples 1-9, wherein selecting one or more actions of the possible actions within the action space that improve performance of the DL-Rec model data ingestion pipeline within the reevaluated environment includes selecting one or more actions according to a reward function that approaches zero as memory consumption nears 100%.

In some examples, a system may include at least one processor and a physical memory including computer-executable instructions that, when executed by the at least one processor, cause the at least one processor to perform various acts. For example, the computer-executable instructions may cause the at least one processor to perform acts including configuring a reinforcement learning system in connection with a DL-Rec model data ingestion pipeline of a DL-Rec model training cluster, the reinforcement learning system including an environment associated with the DL-Rec model training cluster, an RL agent, and an action space of possible actions for the RL agent to take relative to the DL-Rec model data ingestion pipeline, and during data ingestion into the DL-Rec model data ingestion pipeline and execution of a corresponding DL-Rec model, providing live feedback detailing performance of the DL-Rec model data ingestion pipeline to the RL agent, wherein providing the live feedback to the RL agent further causes the RL agent to: reevaluate the environment associated with the DL-Rec model training cluster, select one or more actions of the possible actions within the action space that improve performance of the DL-Rec model data ingestion pipeline within the reevaluated environment, and reallocate computational resources of the environment associated with the DL-Rec model training cluster according to the selected one or more actions.

In some examples, a method may be encoded as non-transitory, computer-readable instructions on a computer-readable medium. In one example, the computer-readable instructions, when executed by at least one processor of a computing device, cause the computing device to configure a reinforcement learning system in connection with a DL-Rec model data ingestion pipeline of a DL-Rec model training cluster, the reinforcement learning system including an environment associated with the DL-Rec model training cluster, an RL agent, and an action space of possible actions for the RL agent to take relative to the DL-Rec model data ingestion pipeline, and during data ingestion into the DL-Rec model data ingestion pipeline and execution of a corresponding DL-Rec model, provide live feedback detailing performance of the DL-Rec model data ingestion pipeline to the RL agent, wherein providing the live feedback to the RL agent further causes the RL agent to: reevaluate the environment associated with the DL-Rec model training cluster, select one or more actions of the possible actions within the action space that improve performance of the DL-Rec model data ingestion pipeline within the reevaluated environment, and reallocate computational resources of the environment associated with the DL-Rec model training cluster according to the selected one or more actions.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of,” Finally, for ease of use, the terms “including” and “having” (and their derivatives), as used in the specification and claims, are interchangeable with and have the same meaning as the word “comprising.”

What is claimed is:

1. A computer-implemented method comprising:
configuring a reinforcement learning system in connection with a deep learning recommender (DL-Rec) model data ingestion pipeline of a DL-Rec model training cluster, the reinforcement learning system comprising an environment associated with the DL-Rec model training cluster, a reinforcement learning (RL) agent, and an action space of possible actions for the RL agent to take relative to the DL-Rec model data ingestion pipeline; and
during data ingestion into the DL-Rec model data ingestion pipeline and execution of a corresponding DL-Rec model, providing live feedback detailing performance of the DL-Rec model data ingestion pipeline to the RL agent;
wherein providing the live feedback to the RL agent further causes the RL agent to:
reevaluate the environment associated with the DL-Rec model training cluster,
select one or more actions of the possible actions within the action space that improve performance of the DL-Rec model data ingestion pipeline within the reevaluated environment, and
reallocate computational resources of the environment associated with the DL-Rec model training cluster according to the selected one or more actions.

2. The computer-implemented method of claim 1, wherein the environment associated with the DL-Rec model training cluster comprises static computational resources, variable RL agent-uncorrelated computational resources, and RL agent-modified computational resources.

3. The computer-implemented method of claim 2, wherein:
static computational resources comprise DRAM-CPU bandwidth and CPU processing speed;
variable RL agent-uncorrelated computational resources comprise DL-Rec model latency; and
RL agent-modified computational resources comprise current latency of the DL-Rec model data ingestion pipeline, a number of available CPUs, and an amount of free memory space.

4. The computer-implemented method of claim 2, wherein reevaluating the environment associated with the DL-Rec model training cluster comprises determining that a change has occurred relative to one or more of the static computational resources or the RL agent-modified computational resources.

5. The computer-implemented method of claim 2, wherein reallocating computational resources of the environment associated with the DL-Rec model training cluster according to the selected one or more actions comprises reallocating one or more RL agent-modified computational resources.

6. The computer-implemented method of claim 1, wherein the RL agent comprises a machine learning model with a three-layer multi-layer perceptron architecture using a ReLU activation function.

7. The computer-implemented method of claim 1, wherein the action space of possible actions for the RL agent to take relative to the DL-Rec model data ingestion pipeline comprises an incremental action space that allows the RL agent to choose to “raise-by-one,” “maintain,” “lower-by-one,” “raise-by-five,” or “lower-by-five” at every step.

8. The computer-implemented method of claim 1, wherein the DL-Rec model data ingestion pipeline comprises a sequence of data processing tasks that transforms a recommender dataset for training the DL-Rec model.

9. The computer-implemented method of claim 8, wherein the sequence of data processing tasks comprises loading samples from a base dataset in a disk read operation, using the samples to fill a batch for DL-Rec model training, shuffling the samples within the batch, optimizing one or more user-defined-functions, and prefetching multiple batches of samples into a GPU memory.

10. The computer-implemented method of claim 1, wherein selecting one or more actions of the possible actions within the action space that improve performance of the DL-Rec model data ingestion pipeline within the reevaluated environment comprises selecting one or more actions according to a reward function that approaches zero as memory consumption nears 100%.

11. A system comprising:
at least one physical processor; and
physical memory comprising computer-executable instruction that, when executed by the at least one physical processor, cause the at least one physical processor to perform acts comprising:
configuring a reinforcement learning system in connection with a DL-Rec model data ingestion pipeline of a DL-Rec model training cluster, the reinforcement learning system comprising an environment associated with the DL-Rec model training cluster, a RL agent, and an action space of possible actions for the RL agent to take relative to the DL-Rec model data ingestion pipeline; and
during data ingestion into the DL-Rec model data ingestion pipeline and execution of a corresponding DL-Rec model, providing live feedback detailing performance of the DL-Rec model data ingestion pipeline to the RL agent;
wherein providing the live feedback to the RL agent further causes the RL agent to:
reevaluate the environment associated with the DL-Rec model training cluster,
select one or more actions of the possible actions within the action space that improve performance of the DL-Rec model data ingestion pipeline within the reevaluated environment, and
reallocate computational resources of the environment associated with the DL-Rec model training cluster according to the selected one or more actions.

12. The system of claim 11, wherein the environment associated with the DL-Rec model training cluster comprises static computational resources, variable RL agent-uncorrelated computational resources, and RL agent-modified computational resources.

13. The system of claim 12, wherein:
static computational resources comprise DRAM-CPU bandwidth and CPU processing speed;
variable RL agent-uncorrelated computational resources comprise DL-Rec model latency; and
RL agent-modified computational resources comprise current latency of the DL-Rec model data ingestion pipeline, a number of available CPUs, and an amount of free memory space.

14. The system of claim 12, wherein reevaluating the environment associated with the DL-Rec model training cluster comprises determining that a change has occurred relative to one or more of the static computational resources or the RL agent-modified computational resources.

15. The system of claim 12, wherein reallocating computational resources of the environment associated with the DL-Rec model training cluster according to the selected one or more actions comprises reallocating one or more RL agent-modified computational resources.

16. The system of claim 11, wherein the RL agent comprises a machine learning model with a three-layer multi-layer perceptron architecture using a ReLU activation function.

17. The system of claim 11, wherein the action space of possible actions for the RL agent to take relative to the DL-Rec model data ingestion pipeline comprises an incremental action space that allows the RL agent to choose to “raise-by-one,” “maintain,” “lower-by-one,” “raise-by-five,” or “lower-by-five” at every step.

18. The system of claim 11, wherein the DL-Rec model data ingestion pipeline comprises a sequence of data processing tasks that transforms a recommender dataset for training the DL-Rec model.

19. The system of claim 18, wherein the sequence of data processing tasks comprises loading samples from a base dataset in a disk read operation, using the samples to fill a batch for DL-Rec model training, shuffling the samples within the batch, optimizing one or more user-defined-functions, and prefetching multiple batches of samples into a GPU memory.

20. A non-transitory computer-readable medium comprising one or more computer-executable instructions that, when executed by at least one processor of a computing device, cause the computing device to:
configure a reinforcement learning system in connection with a DL-Rec model data ingestion pipeline of a DL-Rec model training cluster, the reinforcement learning system comprising an environment associated with the DL-Rec model training cluster, a RL agent, and an action space of possible actions for the RL agent to take relative to the DL-Rec model data ingestion pipeline; and
during data ingestion into the DL-Rec model data ingestion pipeline and execution of a corresponding DL-Rec model, provide live feedback detailing performance of the DL-Rec model data ingestion pipeline to the RL agent;
wherein providing the live feedback to the RL agent further causes the RL agent to:
reevaluate the environment associated with the DL-Rec model training cluster,
select one or more actions of the possible actions within the action space that improve performance of the DL-Rec model data ingestion pipeline within the reevaluated environment, and
reallocate computational resources of the environment associated with the DL-Rec model training cluster according to the selected one or more actions.
